(19) United States
(12) Patent Application Publication
(10) Pub. No.: US 2017/0266635 A1
(43) Pub. Date: Sep. 21, 2017

(54) REACTOR AND PROCESS FOR THE DEHYDRATION OF ETHANOL TO ETHYLENE

(71) Applicant: Petron Scientech, Inc., Princeton, NJ (US)

(72) Inventors: Yogendra Sarin, Plainsboro, NJ (US); Brian Ozero, West Hampton Beach, NY (US); Frank Liotta, Downingtown, PA (US); Hassan Taheri, Chicago, IL (US)

(73) Assignee: Petron Scientech, Inc., Princeton, NJ (US)

(21) Appl. No.: 15/468,348

(22) Filed: Mar. 24, 2017

Related U.S. Application Data
(63) Continuation-in-part of application No. 14/221,036, filed on Mar. 20, 2014, now abandoned.
Application No. 14/221,036 is a division of application No. 13/346,407, filed on Jan. 9, 2012, now abandoned.

(51) Int. Cl. B01J 8/04

(52) U.S. Cl. CPC B01J 8/0496; B01J 8/0492; B01J 8/0446; B01J 2208/00504; B01J 2208/00823

(57) ABSTRACT

A reactor design and configuration and a process for the catalytic dehydration of ethanol to ethylene where the reactor train is comprised of a multi-stage single reactor vessel or multiple reactor vessels wherein each stage and/or vessel has different length, internal diameter, and volume than the other stages and/or vessels and in addition the stages and/or reactor vessels are connected in series arrangement, preferably used with an improved means of introducing the ethanol feedstock and a heat carrying inert gas to the improved reactor train. The inert gas is heated in a separate furnace from the ethanol feed and then injected into the ethanol feed to supply the heat of reaction.

### BACKGROUND OF THE INVENTION

This application is a continuation-in-part of U.S. application Ser. No. 14/221,036 filed Mar. 20, 2014 which is a division of U.S. application Ser. No. 13/346,407 filed Jan. 9, 2012.

### FIELD OF THE INVENTION

Almost all ethylene produced globally today is from fossil fuel/petroleum based feedstocks. This invention relates to an improved technology of reactor design and configuration and a process for the catalytic dehydration of ethanol or bio-ethanol (hereinafter referred to as ethanol) to ethylene wherein the reactor train is comprised of a multi-stage single reactor vessel or multiple reactor vessels wherein each stage and/or vessel has different length, internal diameter, inert beds, and volume than the other stages and/or vessels and in addition the stages and/or reactor vessels which are connected in series and can be installed in a vertical or side by side arrangement. Furthermore, this invention discloses an improved means of introducing the ethanol feed stock premixed with a heat carrying inert gas to the improved reactor train.

### RELATED INFORMATION

Ethylene is the backbone of the petrochemical process industries providing raw materials for many applications including industrial chemicals, consumer products,polymers, plastics, surfactants, etc. This petrochemical feedstock is primarily produced from petroleum resources by the steam cracking of petroleum-derived feed stocks such as heavy naphtha, ethane/propane, or gas condensates from shell gas. The economics of these processes are greatly influenced by the supply, availability, and price of crude oil and natural gas. In addition, the cracking processes produce a large number of valuable byproducts such as propylene, butylene, etc. which require considerable energy per ton of production due to higher cracking temperatures, much more complex processing and distillation, and high capital investment to separate, purify, and market all the products so that the process can be economically justified. If a user of ethylene were only interested in producing ethylene, the cracking route is not an advantageous option. Furthermore, the conventional steam cracking produces large quantities of CO2 (carbon) which is a greenhouse gas. The catalytic dehydration of ethanol to ethylene is a well-known commercial process based on sustainable/renewable feed stock for the selective conversion of the ethanol to value-added ethylene. In the 30's and 40's, several ethanol dehydration units were built which remained in operation until the 60's. The world oil crisis of early 70's accelerated the development of ethanol dehydration technologies with several new plants built in the 80's. However, the dehydration process fell out of favor in the mid 90's due to abundant supply and low price of crude oil and natural gas. Recently, as the biofuels and global warming have attracted more attention globally, as prices of crude oil have fluctuated widely, and as its supply sources have become more unstable and problematic, the alternative route of ethanol dehydration process has again become an important alternative source of sustainable bioethylene supply. In addition, with the threat to the environment and limited resources in some parts of the world, the ethanol dehydration process is being increasingly competitive with the traditional steam cracking process. Additionally, the sources of raw materials for ethanol supply has increased many folds over the last decade from renewable/sustainable sources such as may be readily obtained by fermentation from such diversified bio-resources as sugar cane, corn, sugar beets, other grains, agricultural and cellulosic biomass, or algae based feed stocks or waste gases from steel plants or pulp and paper industry.

The ethanol dehydration reaction basically is characterized by the removal of a water molecule from ethanol and as such is highly endothermic. A significant amount of heat (energy) is thus required to initiate and sustain the reactions to completion. The economic production of ethylene by this process largely depends on the efficient conversion of ethanol feed stock and high selectivity and yield of the ethylene product.

The endothermic dehydration of ethanol to ethylene has been practiced for many years. The early commercial reactors were based on isothermal., multi-tubular shell and tube arrangements in which the reactant ethanol would flow through the reactor tubes which were packed with a fixed bed of catalyst. The required heat of reaction would be supplied by circulating fluid such as molten salt, Dowtherm®, or some other material through the shell of the reactor. Another technology utilized expensive fired heaters handling ethanol to provide heat to reactants in a multi-stage reactor design. Because of the high temperatures required to achieve high conversions for the dehydration reaction and the high cost of the fabrication of such tubular reactors and fired heaters, the multi-tube reactors were replaced by fixed bed, adiabatic reactors which have been in commercial service since the early 70's.

Another technology utilized multiple expensive fired heaters that superheated azeotropic ethanol vapor in the furnace tubes to provide the sensible heat for the dehydration reaction in a multi-stage reactor design. The decomposition of ethanol in the furnace tubes that produced coke and other byproducts required frequent regeneration of the catalyst beds and cryogenic distillation of the crude ethylene to produce chemical-grade ethylene product.

U.S. Pat. No. 4,134,926 discloses a fluidized bed reactor concept for the dehydration of ethanol to ethylene wherein a portion of the dehydration catalyst is continuously withdrawn from the reactor chamber and regenerated with air in a second fluid-bed regenerator. The hot regenerated catalyst is then mixed with fresh make-up catalyst and recycled back to the primary reactor to provide the endothermic heat of reaction. This reactor concept has not found commercial application due to the complexity of the process, the handling and recycle of large quantities of solid catalyst, and continuous replacement of the lost catalyst because of attrition.

U.S. Pat. No. 4,232,179 describes a reactor train invention in which multiple, adiabatic reactor vessels are connected in series arrangement for dehydration of ethanol to ethylene. This patent further teaches the use of a sensible heat carrying fluid such as steam mixed with the ethanol feedstock prior to feeding to individual reactors. Each reactor is packed with a solid catalyst. The energy required for the reactions is supplied by a fired heater wherein both ethanol and steam are heated to very high temperatures needed for the reactions to proceed to completion in each reactor stage. This feature, being similar to British patent 516,360, can also result in lower selectivity and yield of the primary product and the formation of problematic byproducts. In addition, no distinction is made in this disclosure as to the relative sizes of each reactor and the catalyst bed within that reactor with respect to other reactors and/or catalyst beds which make up the reactor train. U.S. Pat. No. 4,396,789 teaches an invention which is basically similar to U.S. Pat. No. 4,232,179 with the exception that the reactor train is designed to operate at a design pressure of between 20 and 40 atmospheres. The patent claims that such high pressure operation will simplify the purification of the crude ethylene product during the subsequent cryogenic distillation to produce high quality ethylene for downstream applications. In all of the above processes, the dehydration catalyst was subjected to carbonization as a result of direct exposure of ethanol to high coil surface temperatures within the preheating and superheating furnaces. This practice would require frequent regeneration of the catalyst bed thus requiring downtime, loss of production, and resulting in shortened catalyst life as well and lower ethylene purity and yields.

It is the general object of this invention to maximize the utilization efficiency of the dehydration of ethanol feedstock to ethylene product while minimizing the production of undesirable by-products and processing steps and improving ethylene yields. The specific goal of the present invention is to provide a novel, adiabatic reactor configuration and process to achieve the desired goals of the invention. Other objects and benefits of the present invention will become apparent from the following disclosure. It is also an object of the present invention to utilize available streams found within a facility or derived from the operation of the reaction carried out in the reactor to improve the thermal efficiency of the process. In this regard each of the stages, are independently sized and the quantity of catalyst therein determined to take advantage of a stream from some other reactor or source within the facility or from other stages within the reactor to obtain the highest yield and selectivity from these disparate sources. It is a particular object of the present invention to design each stage of the reactor considering various sources which can used in the reaction at hand.

### SUMMARY OF THE INVENTION

One aspect of the present invention is an adiabatic reactor train comprising

a) a furnace for superheating an inert gas, the outlet of said furnace connected to a first specially designed in-line static mixer for mixing the hot inert gas with a first fresh ethanol feed;

b) a first inlet connected to said first mixer for feeding said hot inert gas and said first fresh ethanol stream to a first stage containing a first volume of ethanol dehydration catalyst;

c) a first outlet connected to said first stage for removing a first effluent from said first stage; said first effluent containing inert gas, unreacted ethanol and ethylene;

d) a second specially designed mixer connected to said first outlet for mixing a second fresh ethanol stream with said first effluent;

e) a second inlet connected to said mixer for feeding said first effluent and said second fresh ethanol stream to a second stage containing a second volume of ethanol dehydration catalyst, said second volume being different from said first volume;

f) a second outlet connected to said second stage for removing a second effluent from said second stage; said second effluent containing inert gas, unreacted ethanol and ethylene;

g) a third specially designed mixer connected to said second outlet for mixing a third fresh ethanol stream with said second effluent;

h) a third inlet connected to said mixer for feeding said first second and said third fresh ethanol stream to a third stage containing a third volume of ethanol dehydration catalyst, said third volume being different from said first volume and second volumes; and

i) a third outlet connected to said third stage for removing a third effluent from said third stage; said third effluent containing inert gas, unreacted ethanol and ethylene

In another embodiment provision is made for super heated inert gas to be mixed with the combined first effluent and fresh ethanol being fed to the second stage to maintain the inerts:ethanol ratio in the first reaction stage within the predicted optimum range, depending on the total overall inerts:ethanol ratio.

Generally there is no provision to inject superheated inert gas injected into the combined feed to the later stages, i.e., the third stage in as three stage reactor or the third and fourth stage in a four stage reactor.

The main advantage of the present invention is that the fresh ethanol feed is never passed through a furnace but is heated by direct injection of hot inert gas or indirect heat exchange with the hot inert gas or hot reaction effluent gas. This gives better control with uniform heating and prevents cracking and decomposition that occurs if the ethanol contacts the hot (up to 1000° C.) wall of the furnace tubes. As noted above the azeotropic ethanol may be heated by indirect heat exchange with the hot effluent gas from the final reaction stage because the maximum temperature of the tube walls in the heat exchanger will be lower than the reaction outlet gas, which should normally be lower than 400 C.

The multiple reacton stages, whether housed in a single structure or in separate structures, comprise a reactor train in which the dehydration reaction or process is carried out. Each stage is designed to operate under different conditions of temperature, pressure, reactant residence time, and quantity of catalyst than the other stages.

### BRIEF DESCRIPTION OF THE DRAWING

FIG. 1. Shows a single reactor vessel housing three catalyst stages in series with each zone having different length, diameter, volume or catalyst quantity that the other stages and the flow arrangement of the reactant ethanol and inert gas, with the inert gas being superheated twice (in 2 furnaces) to heat the feed gases to the three reaction stages to the required inlet temperatures.

FIG. 2 shows a preferred embodiment of a 3-stage reaction structure similar to that in FIG. 1 in which the addition of a third furnace so that the inert stream (normally steam) can be superheated three times would substantially reduce the overall ratio of inerts to ethanol below that required for the flow scheme in FIG. 1.

### DETAILED DESCRIPTION OF THE INVENTION

Recognizing (i) the short comings of the prior art as noted above, (ii) the key economic drivers needed for bio-ethylene production to compete as replacement for petroleum-derived ethylene, and (iii)the specific quality demands required of any bio-ethylene as feedstock for the traditional uses of these raw materials, this invention provides an improved reactor technology and process to specifically address these issues. This disclosure teaches a novel reactor design and geometry and an improved processing concept to achieve its desired goals. The novel reactor is configured so, the multiple reactor stages and/or reactor vessels are employed in series configuration wherein each stage and/or reactor vessel comprising the reactor train has a different internal diameter, length, volume, and quantity of fixed-bed catalyst than the other stages and/or vessels. Several improvements arise from this novel design whose detail is illustrated below. The number of stages is typically between 2 and 5 and preferably between 2 and 4. Each stage preferably has an internal diameter of between 0.5 to 10 meters at the inlet to the stage and an internal diameter of between 1 to 15 meters at the outlet of the stage with each stage preferably having a length of between 0.3 to 15 meters.

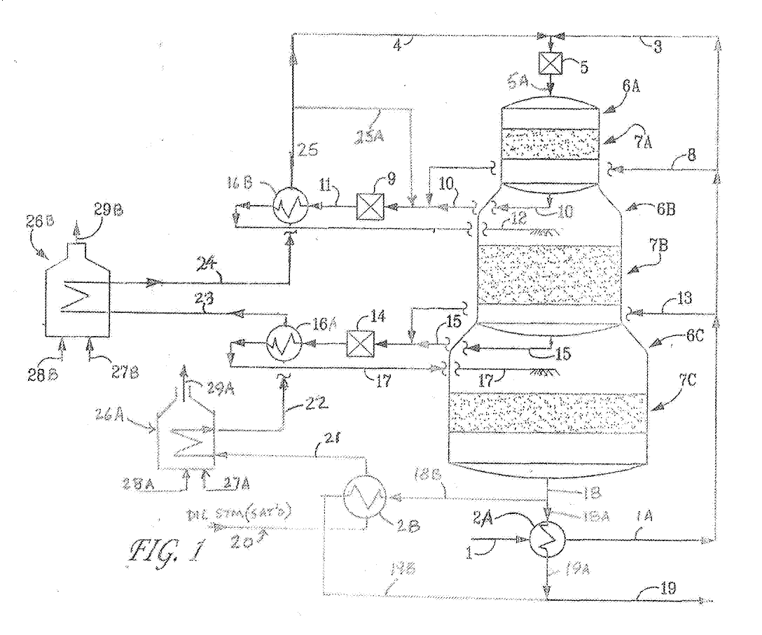

According to this disclosure two embodiments of this reactor design will be described in the following sections. FIG. 1 serves to illustrate one embodiment of this invention, in which one reactor vessel containing three stages connected in series and two furnaces for superheating the inert gas (twice) is employed. The three stages comprise the reactor vessel. Each stage is packed with a suitable fixed-bed dehydration catalyst such as those described in U.S. Pat. Nos. 4,260,845; 4,302,357; 4,529,827; 4,670,620; 4,873,392; and 6, 489, 515 Each stage in this arrangement has a different internal diameter, length, volume, and quantity of catalyst than the other stages. The variable sized stages are uniquely designed for an optimized target production of ethylene in each of them. The benefits and the improvements made possible by this design will become obvious after the detailed explanation of the invention. Hydrous or anhydrous ethanol stream 1 is vaporized and preheated in heat exchanger 2 using the hot reactor effluent gases 18A which then exit as stream 19A to downstream purification sections of the plant (not shown). The preheated ethanol feed stream 1A is not passed through a superheating furnace but is divided into three streams 3, 8, and 13. Stream 3 is combined with superheated inert gas stream 4 and passes through the inline stationary mixer 5 which serves to fully mix the two streams before entering the first stage reactor 6A. Stage 6A houses the fixed-bed 7A. The diameter, length, and the volume of catalyst in this stage is designed for optimum temperature profile and residence time of the ethanol reactant. Typically, the inlet temperature to this stage is between 400 to 550 C and the outlet in the range of 350 to 400 C. The weight hourly space velocity (WHSV) of the ethanol in this stage is in the range of 0.01 to 2 kg ethanol per hour per kg of catalyst. Typically, the weight ratio of the inert gas to ethanol in the inlet to this stage is between 0.5 to 10:1. The operating pressure in this stage may range from 1 (preferably 2) to 15 barg. These conditions are designed to optimize the temperature profile in this stage and to achieve >95% conversion of ethanol and >99.5% selectivity to the corresponding ethylene.

The exit stream 10 from stage 6A containing ethylene from stage 1 and water formed in stage 1 is mixed outside of the reactor vessel with fresh ethanol stream 8 in inline mixer 9 and heated to the desired temperature in exchanger 16B by superheated inert gas stream 24. The heat-providing inert gas to each reactor stage is superheated steam at pressure in the range of 1 to 30 barg and preferably 4 lo 25 barg and at temperature in the range of 300 C to 650 C and preferably 350 to 600 C. The superheated inert gas exiting t from heat exchanger 16B as stream 25 is divided into stream 4 that is fed to the first stage reactor and (if required) stream 25A that is fed to the second stage. The preheated Stream 12 from exchanger 16B is fed to second stage reactor 6B and is distributed into the catalyst bed 7B in this stage. The operating conditions in this second stage include: inlet temperature of 380-530 C, outlet temperature of 300-460 C, ethanol WHSV of 0.01 to 2 kg ethanol/hr/kg catalyst, ethanol to-inert gas ratio of 0.8 to 10:1 and pressure 2 to 15 barg. Again, the conditions are designed such that to obtain optimum temperature profile thought the catalyst bed, to achieve almost complete conversion of ethanol, and to realize >99% selectivity to ethylene.

The effluent stream 15 from second stage reactor is mixed with additional ethanol stream 13 in inline mixer 14, heated in exchanger 16. Exchanger 16 is heated by superheated inert gas 21. The heated stream 17 from exchanger 16 is the feed to reactor stage 6C which contains the 3'd stage catalyst bed 7C. The operating conditions in this stage are also optimized to achieve similar goals of temperature profile and performance as in stages 6A and 6B. The ranges of conditions in this third stage include: inlet temperature of 400-520 C, outlet temperature of 350-420 C, ethanol WHSV of 0.01 to 2 and gas kg gas ratio of 1 to 10:1, and pressure in the range 2 to 15 barg. The exit stream 18 from stage 6C flows to heat exchangers 2 (preheating ethanol stream 1) and is process in downstream equipment to recover the ethylene produce.

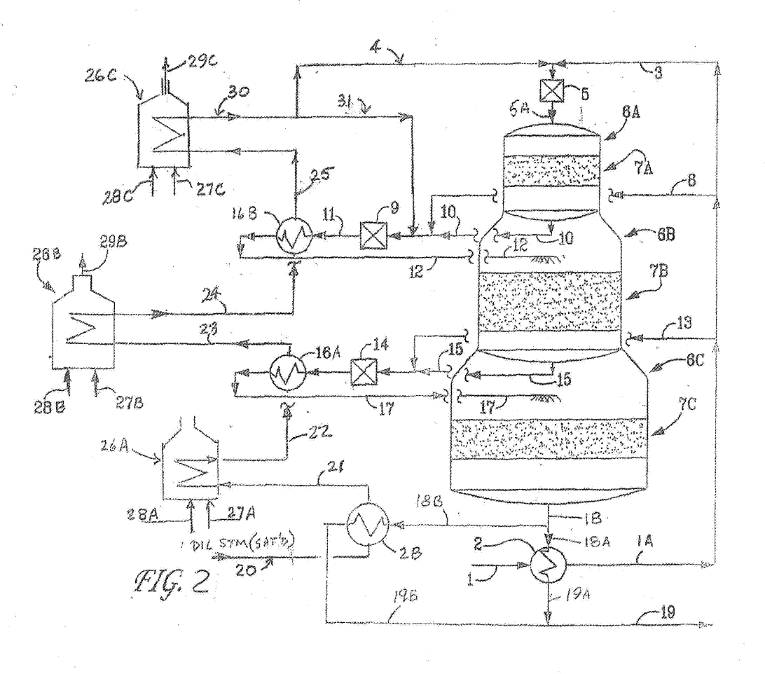

A preferred embodiment that is similar to that shown in FIG. 1 but requires less inert gas per unit production of ethylene by the addition of a third superheating furnace (for the three stage reactor) is shown in FIG. 2. Operating conditions are essentially the same, however the steam flows around stage one are different than FIG. 1. Saturated steam in line 21 is passed through first furnace 26A to be superheated and removed via line 22. The superheated steam in line 22 is indirectly heat exchanged in exchanger 16A with the combined feed to third stage 6C and then reheated in furnace 26B via line 23. The newly reheated steam is removed from the furnace via line 24 and indirectly heat exchanged in exchanger 11 with the combined feed to the second stage 6B. The hot steam in line 25 from exchanger 16B is superheated in the additional furnace 26C and is then injected into both the fresh ethanol feed to the first stage 6A via line 4 and also to the combined feed to the second stage 6B via line 31. As noted, this 3^{rd} stage of superheat (in a 3 stage reaction system) allows for a more efficient use of reaction effluent gas and steam as heat sinks, reduces the required steam (or inert) to ethanol weight ratio and lowers the required outlet temperatures of the steam from the furnaces. This provides for higher efficiencies in the furnaces and better control of the inlet and outlet temperatures to/from the reactor stages.

The operating conditions within the individual reactor vessels in this arrangement are selected to achieve the desired performance criteria of optimum temperature profiles within the catalyst beds, 99.5% overall conversion of ethanol feedstock, and >99.6% selectivity to ethylene product. Typically, the inlet temperature to each reactor vessel is between 400 to 550 C and the outlet in the range of 350 to 450 C. The weighted hourly space velocity (WHSV) of the ethanol in each vessel is in the range of 0.01 to 2 kg ethanol per hour per kg of catalyst. The weight ratio of the inert gas to ethanol in the inlet to this stage is between 0.5 to 10:1. Finally, the operating pressure within each reactor vessel may range from 2 to 15 barg.

To those skilled in the art, the design features as detailed above offer major technical advances and make it possible to realize numerous improvements and advantages over the previous arts. These advances and improvements are noted in the following paragraphs.

As explained before, the catalytic dehydration of ethanol to ethylene is highly endothermic and requires considerable supply of energy to initiate the reaction and drive it to completion. The reaction produces one mole of water for each mole of ethanol reacted according to:

C₂H₅OH→C₂H₄+H₂0

This reaction requires about 400 kcal per kg of ethylene at the normal operating temperatures 300-400 C

A competing intermediate reaction can also take place producing the undesirable by-product diethyl ether (DEE) according to the following reaction:

2C₂H₅OH→(C₂H₅)₂O+H₂O

At elevated temperatures (above 350 C) the DEE decomposes to produce ethylene and water according to the following reaction:

(C₂H₅)₂O→2C₂H₄+H₂0

The key is to maximize the decomposition o the of DEE and thus maximize the selectivity to ethylene product by the optimum arrangement and size of the reactor stages and the staged addition of ethanol and the heat supplying inert gas. Other by-products may also be formed by the secondary reaction of ethylene to other hydrocarbons such as dimerization to 1- and 2 butylene.

The kinetics of the primary reaction are very sensitive to the operating temperature regime within the catalyst bed. At the inlet to the reactor, the temperature has to be high enough to initiate the reactions. If the temperature gas mixture is too high at the inlet region, side reactions of ethanol will occur resulting in unwanted products. This reduces selectivity and yield to the desired ethylene product. As reactants pass through each catalyst bed, the temperature is continuously decreased toward the end of the catalyst bed. At the outlet of the catalyst bed, if the temperature is allowed to cool significantly because of inadequate supply of sensible energy, either ethanol conversion and DEE is not complete thus increasing the required dehydration and DEE in the flowing bed or secondary reactions can occur resulting in unwanted by-products such as aldehydes and dimers of ethylene. Therefore, the temperature profile through the catalyst bed is very critical to optimum performance.

Three design features in this invention combine to result in optimum temperature profile within the individual reactors. First, the multiple staging of the reactors into variable volume compartments allows for the optimum distribution and residence time of the reactant alcohol and inert gas through each stage. The variable volume is achieved by varying the internal diameter of each reactor stage, varying the length of each stage, and/or varying the volume of the catalyst bed within each stage. Stages may have continuously variable internal diameter from the inlet of the stage to the outlet of the stage. The optimization of volume and thus the residence time distribution of the reactants is an important consideration in the kinetics of the dehydration reaction and therefore the optimum utilization of the individual catalyst beds within the reactor stages.

Second, both the ethanol feed and the heat supplying inert gas to each stage are separately and independently fed, controlled, and heated prior to being mixed and distributed to the individual reactor stages. This makes it possible to avoid superheating of ethanol and its thermal degradation. In addition, this feature allows the optimum utilization o {the heat carrying inert gas in relation o the amount of ethanol feed rate. This optimization requires the balancing of sufficient energy supply to each stage but not excessive amounts which will result in economic disadvantage. The design also balances the formation of the water of reaction and the heat supplying inert gas. Furthermore, the design minimizes the formation of by-products such as DEE, aldehydes, or hydrocarbons such as propylene, butylenes, etc.

The third design feature stems from the resulting kinetics of the dehydration reaction made possible by realizing the almost complete conversion of ethanol through the individual reactor stages. Therefore, ethanol recovery and recycle are avoided in this processing scheme.

A further improvement of the present invention is that the economic life of each catalyst bed comprising the reactor train is considerably increased due to the optimum temperature profile within each stage. Therefore, frequent regenerations required in older technologies are avoided. The catalyst employed in this process may be alumina, silica-alumina, zeolites, or other suitable catalysts as are described in the patent literature. See for example U.S. Pat. Nos. 4,260,845; 4302,357; 4,529,827; 4,670,620;4,873,392 and 6,489,515. The longer catalyst life makes it possible for improved asset utilization and efficiency and allows for longer cycle time of the catalyst beds before unit shutdown and replacement are needed.

A further improvement resulting from the reactor design and the staged process for introducing ethanol feed and the heat supplying inert gas into each stage and/or reactor vessel is that each stage may be by-passed to control the production rate, which is an advantage during startup or period of low ethylene production rates.

In addition to the above improvements, other improvements can be readily realized from this invention by those experts familiar with the selective dehydration of ethanol to ethylene.

### EXAMPLES

### Laboratory Reactor

The following experimental examples serve to illustrate the unique features of the present invention and the resulting performance of the dehydration system. An experimental pilot reactor was constructed to allow the simulation of the operating conditions within each reactor stage and the performance testing of the reactor design as taught in this invention. The reactor consisted of a 1 inch OD, 0.870 inch ID, 3.5 feet long fix-bed down flow reactor. The reactor was heated in a three-zone furnace whereby the temperature of each zone could be controlled independently to achieve a desired temperature profile within the catalyst bed. The reactor tube was equipped with a centrally positioned 3/16″ thermowell which housed f I've stationary thermocouples that were equally spaced within the thermowell at 0″, 2″,4″,6″, and 8″ measured from the top of the catalyst bed.

The catalyst used in these experiments was a commercially available high purity and surface area gamma alumina. Approximately 40 CC of this catalyst was loaded into the reactor. An equal volume of inert alpha alumina spheres was mixed with the active catalyst as diluent yielding a total bed volume of ˜80 CC. In addition, the same inert alumina spheres were used as pre- and post-heat zones of the reactor. The complete inertness of the spheres was demonstrated under all the operating conditions by testing the pilot reactor with only the alpha alumina packed inside the reactor tube.

The experimental setup was designed for continuous operation, sampling, and analysis of the products. The operating conditions were selected such that a two-stage design could be fully simulated and tested. The experimental conditions within the two stages as shown in Table 1.

TABLE 1
Conditions

| Operating Parameter | Stage 1 | Stage 2 |
|---|---|---|
| Pressure, barg | 6.45 | 5.95 |
| Inlet temperature, C. | 466 | 453 |
| Outlet temperature, C. | 375 | 374 |
| Feed Ethanol Conc. mol % | 8.75 | 7.60 |
| Feed Water Conc, mol % | 91.25 | 85.15 |
| Feed Ethylene Conc. mol 5 | 0 | 7.25 |
| Ethanol WHSV gr/hr/gr. cat | 0.433 | 0.334 |

The performance measures in these tests included ethanol conversion, ethylene selectivity, and by-products analysis. The by-products included: methane, ethane, propylene, propane, ethanol, acetaldehyde, 1-butane, 2-butane, acetone, diethyl ether, 1-pentene, 1-hexene, and n-hexane, The test results are summarized in Table 2.

TABLE 2
Performance

| Performance Parameter | Stage 1 | Stage 2 |
|---|---|---|
| Ethanol Conversion, % | >99.9 | >99.9 |
| Ethanol Selectivity, % | >99.9 | >99.9 |
| By-products conc., % | ND | ND |

ND: not detected

### Commercial Operation

A commercial two stage ethanol dehydration plant was designed and built according to the present invention. The following summarizes the operation;

Overall Performance

| Total azeotropic ethanol feed | 18.6 tons/hr |
|---|---|
| Total diluent steam | 40.6 tons/hr |
| Overall steam to ethylene ratio | 2.2:1 |
| Overall ethanol conversion | 99.5% |

First Stage Reactor

| | |
|---|---|
| Diluent steam | 40.6 tons/hr |
| Ethanol feed | 10.6 tons/hr |
| Diluent steam to ethanol ratio | 3.8:1 |
| LHSV ethanol feed | 0.3 L/hr/L cat. |
| Temperature - inlet/outlet | 484/395 C. |
| Conversion Ethanol in feed | 97% (est'd) |

Second Stage Reactor

| Ethanol feed | 8.0 tons/hr |
|---|---|
| LHSV of ethanol feed | 0.18 L/hr/L cat. |
| Temperature - inlet/outlet | 444/387 C. |
| Conv. ethanol in feed to 2^{nd} stage | 99.1% (equiv to 99.5% total feed) |
| Ethylene purity | >99.7% |

The invention claimed is:

1. An adiabatic gas phase reactor train for application to catalytic dehydration of ethanol to ethylene process comprising:
a) a furnace for superheating an inert gas. The outlet of said furnace connected to a first mixer for mixing hot inert gas with a first fresh ethanol feed;
b) a first inlet connected to said first mixer for feeding said hot inert gas and said first fresh ethanol stream to a first stage containing a first volume of ethanol dehydration catalyst;
c) a first outlet connected to said first stage for removing a first effluent from said first stage; said first effluent containing inert gas, unreacted ethanol and ethylene;
d) a second mixer connected to said first outlet for mixing a second fresh ethanol stream with said first effluent;
e) a second inlet connected to said mixer for feeding said first effluent and said second fresh ethanol stream to a second stage containing a second volume of ethanol dehydration catalyst, said second volume being different from said first volume;
f) a second outlet connected to said second stage for removing a second effluent from said second stage; said second effluent containing inert gas, unreacted ethanol and ethylene;
g) a third mixer connected to said second outlet for mixing a third fresh ethanol stream with said second effluent;
h) a third inlet connected to said mixer for feeding said first second and said third fresh ethanol stream to a third stage containing a third volume of ethanol dehydration catalyst, said third volume being different from said first volume and second volumes; and
i) a third outlet connected to said third stage for removing a third effluent from said third stage; said third effluent containing inert gas, unreacted ethanol and ethylene.

2. The adiabatic gas phase reactor train according to claim 1 wherein the outlet from said furnace is connected to said second mixer for mixing hot inert gas with said first effluent and said second fresh ethanol feed.

3. The adiabatic gas phase reactor train according to claim 1 further comprising;
j) a first heat exchanger connected to said first outlet between and said second mixer and said furnace outlet for indirectly heating said first effluent and said second fresh ethanol stream; and
k) a second heat exchanger connected to said second outlet between said second outlet and said third mixer and said furnace outlet for indirectly heating said second effluent and said third fresh ethanol stream.

4. An adiabatic gas phase reactor train for application to catalytic dehydration of ethanol to ethylene process comprising:
a) a furnace for superheating an inert gas. The outlet of said furnace connected to a first mixer for mixing hot inert gas with a first fresh ethanol feed;
b) a first inlet connected to said first mixer for feeding said hot inert gas and said first fresh ethanol stream to a first stage containing a first volume of ethanol dehydration catalyst;
c) a first outlet connected to said first stage for removing a first effluent from said first stage; said first effluent containing inert gas, unreacted ethanol and ethylene;
d) a second mixer connected to said first outlet for mixing a second fresh ethanol stream with said first effluent;
e) a second inlet connected to said mixer for feeding said first effluent and said second fresh ethanol stream to a second stage containing a second volume of ethanol dehydration catalyst, said second volume being different from said first volume; and
f) a second outlet connected to said second stage for removing a second effluent from said second stage; said second effluent containing inert gas, unreacted ethanol and ethylene.

5. The adiabatic gas phase reactor train according to claim 4 wherein the outlet from said furnace is connected to said second mixer for mixing hot inert gas with said first effluent and said second fresh ethanol feed.

6. An adiabatic gas phase reactor train for application to catalytic dehydration of ethanol to ethylene process comprising:
a) a furnace for superheating an inert gas, the outlet of said furnace connected to a first mixer for mixing hot inert gas with a first fresh ethanol feed;
b) a first stage inlet connected to said first mixer for feeding said hot inert gas and said first fresh ethanol stream to a first stage containing a first volume of ethanol dehydration catalyst;
c) a first stage outlet connected to said first stage for removing a first effluent from said first stage; said first effluent containing inert gas, unreacted ethanol and ethylene;
d) a second mixer connected to the outlet of said furnace and said first outlet for mixing hot inert gas with said first effluent;
e) a first heat exchanger operationally connect to said first furnace outlet and and said first stage outlet to indirectly head the effluent from said second mixer;
f) a second stage inlet connected to said mixer for feeding said first effluent and said second fresh ethanol stream to a second stage containing a second volume of ethanol dehydration catalyst, said second volume being different from said first volume;
g) a second outlet connected to said second stage for removing a second effluent from said second stage; said second effluent containing inert gas, unreacted ethanol and ethylene;
h) a third mixer connected to said second outlet for mixing a third fresh ethanol stream with said second effluent;
i) a third inlet connected to said mixer for feeding said first second and said third fresh ethanol stream to a third stage containing a third volume of ethanol dehydration catalyst, said third volume being different from said first volume and second volumes;
j) a second furnace for superheating an inert gas, the outlet of said second furnace being operationally connected to a second heat exchanger and said second stage outlet for indirectly heating, the outlet of said second furnace being connected to the inlet of said first furnace; and
k) a third outlet connected to said third stage for removing a third effluent from said third stage; said third effluent containing inert gas, unreacted ethanol and ethylene.
